(19) United States
(12) Patent Application Publication
(10) Pub. No.: US 2024/0278169 A1
(43) Pub. Date: Aug. 22, 2024

(54) PROCESS FOR THE REMOVAL OF ACID GASES, SPECIFICALLY CO2, FROM GASEOUS MIXTURES CONTAINING THEM THROUGH THE USE OF ABSORBENT COMPOSITIONS INCLUDING CYCLIC UREAS AS A PHYSICAL SOLVENT

(71) Applicant: ENI S.P.A., Roma (RM) (IT)

(72) Inventors: Gianluca FIORI, San Donato Milanese (MI) (IT); Alberto Renato DE ANGELIS, San Donato Milanese (MI) (IT)

(21) Appl. No.: 18/567,116

(22) PCT Filed: Jun. 15, 2022
(86) PCT No.: PCT/IB2022/055537

§ 371 Date: Dec. 5, 2023

(30) Foreign Application Priority Data
Jun. 16, 2021 (IT) 102021000015701

(51) Int. Cl. B01D 53/14; B01D 53/62; B01D 53/78; B01D 53/96

(52) U.S. Cl. CPC B01D 53/1493; B01D 53/1425; B01D 53/1475; B01D 53/62; B01D 53/78; B01D 53/96; B01D 2252/20463; B01D 2252/20468; B01D 2252/20489; B01D 2252/2053; B01D 2252/504; B01D 2257/504

(57) ABSTRACT

An absorbent mixture for the removal of acid gases from gas mixtures includes:
A) at least one alcohol of general formula R(OH)ₙ, wherein R is an optionally substituted linear or branched alkyl or alkylaromatic group, with 2-20 carbon atoms and n is an integer that varies between 1-20;
B) at least one organic base with a pK_{b} (in water) less than or equal to 3;
C) a solvent based on one or more heterocyclic compounds selected from cyclic ureas with a 5 or 6 atom ring of formula (IV) and/or (V); cyclic lactams with a 5 or 6 atom ring of formula (VI) and/or (VII); or combinations thereof:

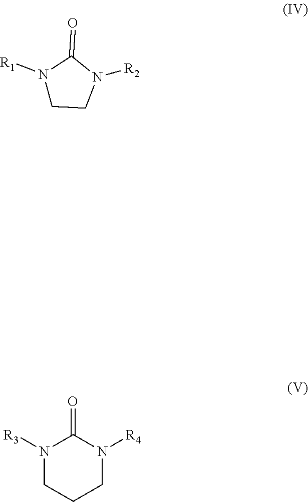

Where R1, R2, R3, R4 are independently selected from H, alkyl groups, linear or branched, with 1-10 carbon atoms;

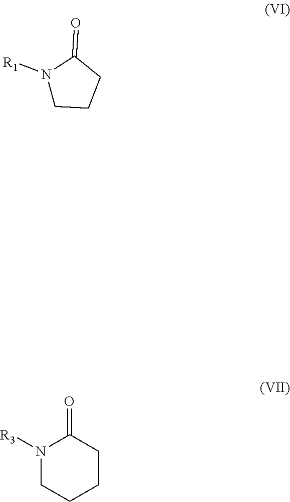

Where R1 and R3 are independently selected from H, alkyl, linear or branched groups with 1-10 carbon atoms.

### CROSS-REFERENCE TO RELATED APPLICATIONS

This application is a 35 U.S.C. § 371 National Stage patent application of PCT/IB2022/055537 filed 15 Jun. 2022, which claims the benefit of Italian patent application 102021000015701 filed 16 Jun. 2021, the disclosures of which are incorporated herein by reference in their entirety.

### TECHNICAL FIELD

The present disclosure relates to a process for the removal of acid gases (or sour gases, according to the most commonly used English terminology) from gas mixtures containing them.

Specifically, the present disclosure relates to a process for the removal of acid gases, especially CO₂ but also NOx, SOx, present in gaseous compositions, optionally containing also water, for example in the form of water vapour, such as, for example, natural gas, air, burned gas, flue gas (smoke exhaust from a combustion process) and more generally gas effluents from industrial processes, comprising CO₂, H₂O, nitrogen (optionally in the form of NOx) and oxygen, or syngas comprising CO₂, CH₄, H₂, H₂O.

### BACKGROUND

Acid gases such as, for example, CO₂, H₂S, COS or mixtures thereof, are contained in numerous gases or gas mixtures present in the natural environment (air) or are industrially produced.

The presence or emission of acid gases is detrimental, given that these gases are responsible for a number of damaging or harmful phenomena such as corrosion, acid rain, poisoning, lung diseases, the greenhouse effect, etc.

Their control and/or their elimination is a more current problem than ever in terms of safety and the fight against climate change.

A large amount of CO₂ is produced in industrial processes and combustion, such as in diesel or Otto cycle (petrol) engines, in cement factories, in the steel industry, in thermoelectric power plants and subsequently released into the environment, where it contributes to increasing the warming of the biosphere.

The selective absorption of H₂S and/or CO₂ has recently become the subject of an increasing number of study and research projects, as well as industrial implementation projects.

Numerous methods and cycles of abatement of acid gases have been proposed in the past, the efficiency of which can reach a residual content of acid gas in the purified gas stream in terms of ppm and, in some cases, in terms of ppb.

The most commonly used are the washing systems of gaseous mixtures to remove acid gases, involving a treatment with an aqueous solution of amines, the composition of which is dependent on the relative content of CO₂ and/or H₂S.

For example, aqueous solutions of methyldiethanolamine (MDEA) are used, which are resistant to both thermal and chemical degradation, are non-corrosive and have a low heat of reaction with H₂S and CO₂. Furthermore, MDEA mixes little with hydrocarbons and does not form carbamates such as primary and secondary amines, due to the absence of hydrogen atoms bonded to nitrogen.

Its main disadvantage is its lower propensity to absorb CO₂. Where a high percentage of carbon dioxide removal is also required, one or two more reactive amines, primary or secondary (MEA, i.e., methylethylamine or DEA, i.e., diethylamine), can be added, which can greatly improve the speed of total reaction of the solution without affecting the advantageous properties of the MDEA. In this case, the costs of the process obviously increase, as does the degradation of the primary amines, which are thermally less stable than the MDEA.

As an alternative to aqueous solutions of alkanolamines for the absorption of CO₂, some non-aqueous liquid absorbent systems based on other solvents have been proposed. Alkanolamines and amines have been combined with alcohols, diols and cyclic carbonates in various publications to form “hybrid solvents”, the reaction mechanisms and kinetics of which have been studied in the literature, such as, for example, in Alvarez-Fuster, et al., Chem. Ing. Sci. 1981,36, 1513; Ali, et al., Separation and Purification Technology 2000, 18, 163; Usubharatana, et al., Energy Procedia 2009, 1, 95; and 15Nov. 2017 2 Park, et al., set. Sci. Technol. 2005, 40, 1885.

Ionic liquids are another non-aqueous solvent, currently under development for the absorption of CO₂.

They generally consist of pairs of ions which are found in a liquid state close to room temperature in the absence of other solvents. They have low regeneration requirements (temperatures, energy), but have not outperformed aqueous amine solutions due to factors such as low CO₂ carrying capacity at low pressures and high viscosity, as well as having a cost high, which has so far hindered its industrial development for such use.

However, the use of a non-aqueous liquid solvent to separate CO₂ from gas mixtures containing water vapour can lead to the accumulation of H₂O in the liquid solution as either a single-phase or two-phase solution, depending on the process conditions (e.g., pressure, temperature, concentration of H₂O) and the affinity of the non-aqueous solvent for H₂O. The accumulation of H₂O is detrimental to the CO₂ separation and purification process, as more energy is required for solvent regeneration due to the need to continuously remove water from the solvent.

Another group of non-aqueous liquids that have been proposed to solve many of the problems affecting the separation of CO₂ from gas mixtures containing it are switchable ionic liquids at room temperature. These are equimolar mixtures of amidine or guanidine nitrogenous bases and alcohols, which, as such, constitute non-ionic liquids at room temperature, but which form ionic liquids by reaction with CO₂ at room temperature. Typically, the conductivity of switchable ionic liquids increases by one or two orders of magnitude when CO₂ is added.

Importantly, these solvents allow for higher CO₂ loads than some aqueous amines and can be regenerated under milder conditions.

CO₂ is captured through the formation of alkyl carbonates according to the following reaction mechanism:

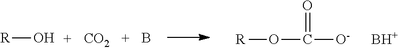

The mechanism indicated in the previous reaction is possible for a generic molecule of formula XO₂, where X is, as in the previous case, C or X═S or N.

Patent application US2012/060686 describes a system for absorbing CO₂ from gas mixtures resulting from combustion which uses the combination of a strong nitrogenous base such as DBU or guanidine and a lower basic alkylamine, such as aniline or piperidine, possibly in the presence of organic solvents such as toluene, tetrahydrofuran or dimethyl sulfoxide (DMSO). The text mentions the formation of carbamates during the absorption of CO₂.

The formation of carbonates or carbamates is not possible for other acid molecules present in natural gas, such as H₂S, which can still be captured by salification, given the high basicity of some of the compounds used in the technique for the formation of ionic liquids, but in often unsatisfactory quantity, especially in the case of high concentrations of H₂S and/or a request to obtain low residual concentrations of H₂S, for example, lower than 1000 ppm.

Ionic liquids also have the disadvantage of significantly increasing their viscosity when the concentration of CO₂ or other acid gas absorbed is very high, thus making the CO₂ separation process more onerous in terms of pressures and energy required for their movement.

A process capable of effectively removing sour gases from a gaseous source such as natural gas, enabling even higher absorption efficiency, lower increase in the viscosity of the fluid during absorption and easy subsequent separation of gases, for example, at relatively low temperatures, to allow for the easy regeneration and recycling of the washing solution in industrial processes, has been proposed by the Applicant in the international application published under number WO 2020/053116 A1.

The process described therein makes use of an absorbent composition comprising: a) at least one alcohol of general formula R(OH)ₙ; b) at least one strong organic base (super-base); c) a physical solvent selected from sulfoxides, sulfones, amides and aromatic nitro compounds.

The process described in WO 2020/053116 A1 enables the obtaining, in a single step, of the removal from gaseous streams of all acid gases and possibly also of other unwanted substances such as mercaptans, with a simplification of the plant scheme, avoiding strongly alkaline substances (corrosive and with a high environmental impact), also requiring lower energy consumption for the regeneration of the absorbent solution.

Although the process described above was found to be efficient in eliminating acid gases from a natural gas mixture, a disadvantage was nevertheless highlighted due to the fact that the absorbent composition containing the absorbed CO₂ showed, even in the presence of the physical solvent such as example sulfolane, a high dynamic viscosity at the same temperature, e.g., 25° C. or 40° C.: this is disadvantageous as the higher the viscosity, the greater the energy required for handling the absorbent composition containing the absorbed CO₂.

Furthermore, the higher viscosity can lead to packing problems in the absorption column, generally containing filling bodies able to increase the contact surface between the two fluids and also in the regeneration column, albeit to a lesser extent due to the higher temperature.

### SUMMARY

Moreover, it would be highly desired that the system absorbing CO₂, NOx, SOx or mixtures thereof shows a higher release of sour gases (higher desorption) with respect to other known systems, at equal temperature of regeneration, so as to perform the regeneration at low temperatures, even lower than 70° C., in order to obtain an energy saving.

It would therefore be advantageous to formulate a new process capable of effectively removing sour gases, particularly CO₂, NOx, SOx from gas mixtures, even from those including water/water vapours, by using an absorbent system which shows a minor increase in viscosity following the absorption of the acid gas and which shows a regeneration that can be achieved at relatively low temperatures, even below 70° C., to enable CO₂ to be removed from the absorbent system (regeneration) and that uses physical solvents that are stable to hydrolysis, in particular to basic hydrolysis.

The Applicant has been able to develop an absorbent composition for the removal of acid gases, particularly CO₂, NOx, SOx or mixture thereof, from gaseous mixtures containing them and the relative procedure for the removal of said acid gases which makes use of this composition, solving the above problem and presenting further advantages over the prior art.

The present disclosure therefore constitutes an absorbent mixture usable for removing acid gases, such as for example CO₂, NOx, SOx or mixture thereof, from gas mixtures containing them comprising
A) at least one alcohol of general formula R(OH)ₙ with a normal boiling point equal to or greater than 75° C., preferably equal to or greater than 100° C., wherein R is a linear or branched alkyl or alkyl aromatic group, possibly substituted, with a number of carbon atoms of between 2 and 20 and n is a variable integer between 1 and 20;
B) at least one organic base with a pK_{b} (in water) less than or equal to 3, preferably less than or equal to 2;
C) a solvent based on one or more heterocyclic compounds selected from the group formed by cyclic ureas having a ring with 5 or 6 atoms of formula (IV) and/or (V); cyclic lactams with a ring of 5 or 6 atoms of formula (VI) and/or (VII); or combinations thereof:

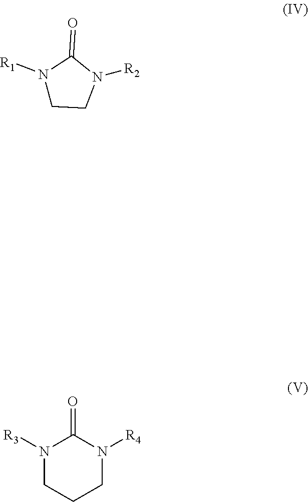

wherein R1, R2, R3, R4 in formula (IV), (V) are independently selected from H, linear or branched alkyl groups with a number of carbon atoms between 1 and 10, said R1, R2, R3, R4 optionally including, independently from one another, one or more —OH groups;

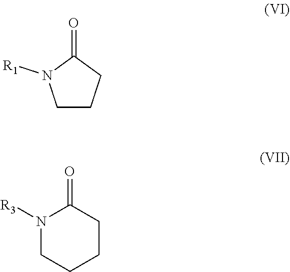

wherein R1, R3 in formula (VI), (VII) are independently selected from H, linear or branched alkyl groups with a number of carbon atoms between 1 and 10, said R1, R3, being able to optionally include, independently from one another, one or more —OH groups.

The embodiments of the claimed disclosure in which the term “comprising” must be interpreted as “essentially consisting of” or “consisting of” are also to be considered included in the scope of this patent application, even if not explicitly stated.

Also, the mixtures obtained between two or more of said elements, unless otherwise specified, are also to be considered included in the scope of the definition of any component or compound comprising more than a single element.

In the present description and in the claims, the term “normal boiling point” refers to the boiling temperature of a liquid at a pressure of 0.1013 MPa (1 atm).

Unless otherwise specified, the extreme values of the numerical intervals, however defined, are to be considered included in the range of the interval.

### DETAILED DESCRIPTION OF THE DISCLOSURE

The combined use of a compound A) and a compound B) as defined above produces, at room temperature, a non-ionic liquid which is however capable of forming an ionic liquid by reaction in situ with CO₂ or with NOx, SOx or mixtures thereof (switchable ionic liquid): component C) of the aforementioned absorbent mixture acts as a physical solvent which also facilitates the physical absorption (absorption) of the CO₂ (or NOx, SOx or mixtures thereof) in the mixture A)+B)+C), as well as decreasing the viscosity of the absorbent mixture containing CO₂ (or NOx, SOx or mixtures thereof) as will be explained in detail below.

In accordance with the present disclosure, components A), B) and C) are included in said absorbent mixture, preferably in the following proportions by weight:
B/A of between 0.1 and 2.5, more preferably between 0.3 and 1.8;
C/A of between 0.1 and 2, more preferably between 0.5 and 1.5.

Alcohol A) can be advantageously selected from any of the following classes:
linear or branched aliphatic alcohols, optionally fluorinated, with a single —OH group (n=1) and having 4 to 20, preferably 5 to 15, carbon atoms;
aliphatic polyols with 2 to 10, preferably 2 to 5, more preferably 2 or 3, —OH groups (n from 2 to 10, preferably from 2 to 5, more preferably 2 or 3) and with 2 to 20, preferably 2 to 10, carbon atoms;
alkyl aromatic alcohols with 1 to 3 aliphatic OH groups (n from 1 to 3) and 7 to 15 carbon atoms, comprising at least one aryl group.

Alcohols A) preferred for the formation of the absorbent mixture in accordance with the present disclosure are butanol, hexanol, heptanol and octanol amongst the mono-alcohols; hexandiol, ethylene and propylene glycol amongst the diols; glycerin amongst the triols; benzyl alcohol amongst the alkylaromatics; 2,2,3,3-tetrafluoropropanol amongst the fluorinated alcohols.

As component A) of the present absorbent mixture, a combination of several alcohols included in the above definition of component A) can also be used.

In preferred embodiment, component A) is 1,2-propandiol or 1,3-propandiol, or mixtures thereof.

In the absorbent mixture according to the present disclosure, said organic base B) can generally be selected from amongst the strong organic bases, as defined above, with low volatility, or generally with a normal boiling point at least higher than 75° C., preferably at least higher than 100° C., more preferably higher than 130° C., or most preferably between 130° C. and 300° C.

Preferably, said organic base B) has a pK_{b} greater than 0.3, preferably greater than 0.5, where pK_{b}, according to the known definition in chemistry, refers to the antilogarithm of the dissociation constant of said organic base B) in water.

In an embodiment of the present disclosure, said organic base B) has a pK_{b} of between 0.3 and 2, more preferably between 0.5 and 2.

Preferably, said organic base B) is a nitrogenous organic compound with low volatility, of between 5 and 25, preferably with 5 to 20 C atoms and with 1 to 10, preferably 2 to 6, N atoms.

Conveniently, said organic base B) has the following

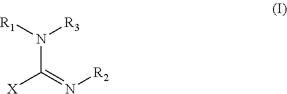

general formula (I):
wherein:
R₁ is a linear or branched C1-C5 alkyl group; or it is an aryl group of 6 to 10 carbon atoms, optionally substituted with a linear or branched C1-C5 alkyl group; or, together with X, it forms a saturated or unsaturated cycle of 5 to 9 members;
R₃ is a linear or branched C1-C5 alkyl group; or it is an aryl group of 6 to 10 carbon atoms, optionally substituted with a linear or branched C1-C5 alkyl group; or, together with R₂, forms a cycle of 5 to 7 members;
X is the —NR₄R₅ group or linear or branched C1-C5 alkyl group, or X can represent a group of formula (II):

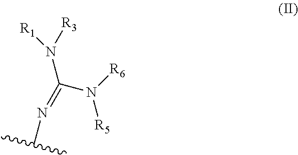

R₂ is hydrogen, a linear or branched C1-C5 alkyl group; or, together with R₃, it forms a 5 to 7-member cycle comprising at least two nitrogen atoms; or it is an aryl group with 6 to 10 carbon atoms, optionally substituted with at least one linear or branched C1-C5 alkyl group, or it is a C7-C12 alkylaryl group, such as, for example, benzyl;
or R₂ can represent a group of formula (III):

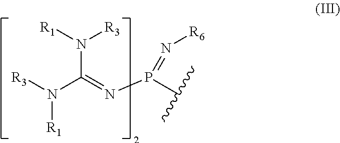

wherein:
the graphic symbol [symbol] represent the group in formula (I) to which X or R₂ is linked;
R₄ is a linear or branched C1-C5 alkyl group;
R₅ is a linear or branched C1-C5 alkyl group;
R₆ is hydrogen or a linear or branched alkyl group, C1-C5;
and mixtures thereof.

An aryl group refers to phenyl or naphthyl.

In a preferred aspect of the present disclosure, R₁, R₃, R₄, R₅ and R₆ correspond to a methyl group and R₂ is hydrogen or methyl.

The organic bases of formula (I) are conveniently selected, for example, from between 1,8-diazabicyclo(5.4.0)undec-7-ene (DBU) [pK_{b} 1.1], 1,5-diazabicyclo[4.3.0]non-5-ene (DBN) [pK_{b} 0.5], 1,1,3,3-tetramethylguanidine (TMG) [pK_{b} 0.4], derivatives of biguanide (1-(diamminomethylidene) guanidine such as N″-[(dimethylamino) (methylimino)methyl]-N,N,N′,N′-tetramethyl-guanidine, 1,8-bis-(tetramethylguanidine)naphthalene, phosphazene-type compounds such as N-phosfinimilidinetris[N,N,N′,N′-tetramethylguanidine], or mixtures thereof, as shown below.

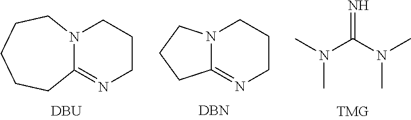

### N″-[(dimethylamino) (methylimino)methyl]-N,N,N′,N′-tetramethyl-guanidine

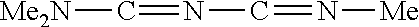

### 1,8-bis (tetramethylguanidine) naphthalene

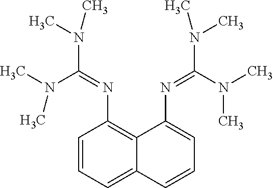

### N″,N′″″,N″″″″-phosfinimilidinetris [N,N,N′,N′-tetramethylguanidine]

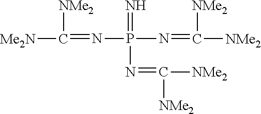 [SMILES: CN(C)C(=NP(=N)(N=C(N(C)C)N(C)C)N=C(N(C)C)N(C)C)N(C)C]

Other organic bases B) suitable for the present disclosure are, for example, quinuclidine (1-Azabicyclo [2.2.2] octane) [pK_{b}=3], and 1,8-bis (tetramethylamino) naphthalene (N, N, N′, N′-tetramethyl-1,8-diaminonaphthalene).

Numerous examples of possible organic bases can be found in the following literature reference: “Superbase for organic synthesis” edited by T. Ishikawa, ed. Wiley and sons, 2009.

As component B) of the present absorbent mixture, a combination of several strong organic bases included in the above definition of component B) can also be used.

In a preferred embodiment of the present disclosure, the superbase B) is 1,8-diazabicyclo (5.4.0) undec-7-ene (DBU). The C) compounds of formula (IV), (V), (VI), (VII) used as physical solvent in the absorbent mixture according to the present disclosure are liquid polar compounds at a temperature of 15° C., generally aprotic, preferably polar aprotic.

Furthermore, they generally show a boiling temperature at normal pressure equal to or higher than 140° C., preferably higher than 150° C.

Said solvents C) also have a viscosity p at 25° C. generally lower than or equal to 40 cP, preferably lower than or equal to 20 cP.

Furthermore, said solvents C) generally show a dielectric constant s at 25° C. greater than or equal to 30, preferably between 35 and 60.

Amongst the cyclic ureas of formula (IV), (V) the following can be mentioned:
1,3-dimethyl-imidazolidin-2-one (DMI) (T. eb.=225° C., ε=37.6 [25° C.], μ=1.94 CPoise [25° C.]) belonging to formula (IV), wherein R₁═R₂═CH₃;
1,3-dimethyl-3,4,5,6-tetrahydro-2(1H)-pyrimidinone (DMPU) (T. eb.=246° C., ε=36.2 [25° C.], μ=3.11 CPoise [25° C.]) belonging to formula (V), wherein R₃═R₄═CH₃.

Amongst the cyclic lactams of formula (VI), the following can be mentioned:
1-Methyl-2-pyrrolidone (NMP) (T. eb=202° C., ε=32.2 [25° C.], μ=1.67 CPoise [25° C.]), wherein R₁═CH₃;
N-Ethylpyrrolidone (CAS No.: 2687-91-4) wherein R₁=CH₂CH₃;
N-(2-hydroxyethyl)-2-pyrrolidone (CAS No.: 3445-11-2) wherein R₁═CH₂CH₂OH.

Specific examples of cyclic lactams belonging to the formula (VII) are 2-Piperidinone (5-valerolactam or 2-piperidone).

The compounds of formula (IV), (V), (VI), (VII) indicated above, suitable as solvents C) in the absorbent mixture of the present disclosure, are also preferably selected from those which are not reactive towards one of the components present in the gaseous mixture to be treated for the removal of acid gases.

It should be noted that the compounds of formula (IV), (V), (VI), (VII) indicated above as component C) have proven to be solvents resistant to hydrolysis, specifically in a basic environment such as that of work in the process in accordance with the disclosure, which is a particularly advantageous feature when the gaseous composition to be treated contains possibly also water or water vapour in significant or, in any case, not negligible quantities in addition to CO₂, NOx, SOx or mixture thereof, such as, for example, gaseous compositions such as natural gas, air, burnt gases, flue gases, and more generally gases from industrial process, including CO₂, H₂O, nitrogen (even also in form of NOx) and oxygen, or syngas including CO₂, CH₄, H₂, H₂O, in which water can be contained in quantities of up to 15% by volume.

The term “resistant to hydrolysis” is herein intended to identify a compound that:
does not undergo the breaking of one or more chemical bonds in the molecule by water, possibly even in the presence of acid or base, preferably in the presence of a base;
should it undergo said breakdown by water, possibly also in the presence of acid or base, preferably in the presence of a base, the quantity of compound in hydrolysed form is less than 1% in moles, preferably less than 0.8% in moles, with respect to the initial moles of compound before breaking.

In an embodiment of the present disclosure, the solvent C) is selected from the class of cyclic ureas of formula (IV) or (V), or mixtures thereof, preferably 1,3-dimethyl-imidazolidin-2-one (DMI), 1,3-dimethyl-3,4,5,6-tetrahydro-2 (1H)-pyrimidinone (DMPU).

In another preferred embodiment, the solvent C) is 1,3-dimethyl-imidazolidin-2-one belonging to the formula (IV).

Of particular preference is the absorbent mixture comprising:
A) 1,2-propandiol o 1,3-propandiol in a weight percentage of between 45% and 65%;
B) diazabicycloundecene (DBU) in a weight percentage of between 25% and 35%;
C) at least one cyclic urea of formula (IV), (V) or at least one lactam of formula (VI), (VII), as defined above, preferably a cyclic urea of formula (IV), (V), more preferably 1,3-dimethyl-imidazolidin-2-one, in a weight percentage of between 5% and 25%,
wherein the weight content of each component A), B) and C) is selected in such a way that their sum is 100%.

The absorbent mixture consisting of components A), B), C) in accordance with the present disclosure can be used for carrying out a process of removing acid gases as above defined from a gaseous mixture as above defined containing them, which is also an advantage of the present disclosure.

The process of removing acid gases from a gaseous mixture containing them, which is an advantage of the present disclosure, comprises the following stages in sequence:
(a) placing said gaseous mixture, at a temperature between 0° C. and 100° C., in contact with a solvent system comprising an absorbent mixture comprising components A), B) and C) in accordance with the present disclosure, to obtain a purified gaseous mixture and a liquid solution comprising at least a part of said acid gases;
(b) separating the purified gaseous mixture from said liquid solution obtained in step (a);
(c) regenerating the solvent system usable in step (a) and forming a separate gaseous mixture comprising said acid gases, preferably by heating said liquid solution separated in step (b).

The gaseous mixture containing acid gases that is fed to stage (a) can be advantageously a gaseous stream containing, as acid gases, CO₂, SOx, NOx or mixture thereof, preferably not containing H₂S, and consisting, for example, of natural gas, air, flue gas (exhaust smoke from a combustion process) including CO₂, H₂O (possibly in the form of water vapour), nitrogen and oxygen, and more generally discharge gases of industrial process or syngas comprising CO₂, CH₄, H₂, H₂O (possibly in the form of water vapour), preferably flue gas.

In the case of natural gas, the CO₂ content is generally around 15-16% in volume, even up to concentrations greater than 30% in volume, with respect to the total volume of natural gas, with a gas stream pressure of generally around 30 bar.

In the case of flue gas, the CO₂ content can generally vary from 2% to 20% by volume with respect to the total volume of the flue gas, with substantially atmospheric or slightly higher pressure of the gaseous stream.

In one embodiment, the above process is used to remove the acid gases CO₂, NOx, SOx or mixture thereof from gaseous streams that contain them, optionally containing water/water vapour, and that do not contain H₂S.

The aforementioned acid gas removal process can be carried out in a continuous or batch reactor, according to the known process techniques.

The pressures in said stage a) are substantially those which have the gaseous streams produced by natural gas (inlet pressure at stage a) higher than atmospheric), flue gas (inlet pressure at stage a) substantially atmospheric) or syngas (pressures of up to 25 bar when obtained by partial catalytic oxidation): they can be between 50 kPa (0.5 bar) and 15 MPa (150 bar), preferably between 100 kPa and 5 MPa, depending on the gas stream to be treated.

Said stage a) can be conducted in any equipment conventionally used for this purpose, such as an absorption tower, an autoclave or others.

Those skilled in the art can easily size the equipment on the basis of known knowledge for this type of unit operation and the characteristics of the solvent system used in the disclosure (viscosity, absorption capacity at saturation, etc.).

With the process forming an advantage of the present disclosure, the removal of all unwanted substances is obtained in a single step, with a simplification of the plant scheme, also requiring a lower energy consumption for the regeneration of the absorbent mixture containing the acid gas.

The process of removing the unwanted acid gases by absorption in the solvent system comprising the absorbent mixture of the present disclosure takes place in step a), by treating the starting gaseous mixture with said solvent system, at temperatures of between 0° C. and 100° C., preferably of between 0° C. and 80° C., more preferably of between 10° C. and 70° C.

Based on the working temperature of stage a) and the pressure, the alcohol A) of the absorbent mixture (as well as component B)) will be selected so that it does not evaporate at the working conditions of stage a).

The gaseous mixture is then purified (i.e., softened) during stage a), removing unwanted substances, e.g., CO₂ and can then be used in any desired way.

In continuous, steady-state industrial applications, the solvent system fed to step (a) is preferably formed largely by the solvent system regenerated in step (c) of the present process, except for any make-up part.

Said solvent system may also include, in addition to the absorbent mixture in accordance with the present disclosure, a residue of acid gases not separated in step (c), without thereby departing from the scope of the present disclosure.

It should be noted that the compounds of formula (IV), (V), (VI) and (VII) surprisingly showed the formation, after the reaction of the solvent system with CO₂, of a system with a lower viscosity than that resulting from the use of other solvents used in the art as physical solvents.

Furthermore, after the reaction of the solvent system of the disclosure with CO₂, no phenomena involving the formation of two-phase solutions of different densities or of turbid solution were observed, phenomena that can pose a problem for the subsequent separation of CO₂ from the absorbent mixture by means of thermal desorption.

In fact, the formation of an undesirable two-phase system can take place when a known inert solvent belonging to the class of aliphatic or aromatic organic liquids such as hexadecane as diluent is used, resulting in a light phase that overcomes the heavy phase constituted by the alkyl carbonate that has formed.

In step (a), the solvent system and the gaseous mixture containing the acid gases are conveniently brought into contact according to one of the known methods for extraction and absorption processes of this type, in co-current or counter-current, dispersing the gaseous mixture in the liquid to maximise the contact between the two phases, for example, by agitation and dispersion of the gas in the liquid or by dripping and nebulisation of the liquid in the gas.

The contact time of the two phases in step a) can be selected by the person skilled in the art on the basis of known parameters of absorption kinetics, or by means of simple preliminary measurements and is normally between 1 and 100 minutes, preferably between 2 and 30 minutes.

The quantity of acid gases absorbed in step (a) can vary within wide limits depending on the characteristics of the solvent system, the pressure and concentration of the acid gases in the gas mixture supplied, as well as the system temperature and the contact time.

In general, the procedure takes place in such a way as to bring the solvent system close to the degree of saturation under the selected operating conditions and so that in the purified gaseous mixture there is the least possible quantity of residual acid gas, preferably below the maximum values permitted in the specification.

In step (a), is present, H₂S must be removed from the purified gaseous mixture down to very low final values, in many cases not exceeding 10 ppm.

In step (b) of the process according to the present disclosure, the separation of the purified gaseous mixture from the liquid solution formed by absorption of the acid gases in the solvent system is carried out.

This separation of step (b) can also take place simultaneously with the absorption reaction (a), in a single, specially designed reactor, in which, for example, the gaseous mixture containing the acid gases is fed from below and placed in continuous contact against the current, with the absorbent mixture fed at the head of the reactor and flowing downwards by gravity.

In a second, non-limiting embodiment of the present disclosure, the mixture formed by mixing the gaseous mixture with the solvent system A)+B)+C) of the disclosure can be separated in a chamber other than the absorption chamber, possibly with the support of a centrifugation system.

In step (c) of the process according to the present disclosure, the liquid solution obtained in step (b), or in steps (a)+(b) at the same time, is treated so as to regenerate the solvent system that can be used in step (a), forming a separate gaseous mixture containing the acid gases.

According to a preferred embodiment, in step (c), the liquid solution resulting from step (b) is heated to temperatures sufficient to remove the desired quantity of acid gases.

In one embodiment the temperature of step (c) is between 40° C. and 180° C., preferably between 50° C. and 180° C.

In another embodiment, the temperature of stage (c) is between 40° C. and 150° C., preferably between 50° C. and 150° C.

In one embodiment, the temperature of step (c) can be between 60° C. and 130° C., preferably between 80° C. and 130° C.

In another embodiment, the temperature of step (c) is lower than 100° C., preferably between 40° C. and 100° C., preferably between 50° C. and 90° C.

The solvent system thus regenerated, containing the absorbent mixture, can be recycled to the absorption step (a).

The process according to the present disclosure can also comprise an additional optional step (d), in which said solvent system regenerated in step (c) is recycled to said step (a).

Optionally, the person skilled in the art can also use, in step (c), a stream of inert gas, such as nitrogen or methane, to facilitate the removal of acid gases from the liquid solution.

Step (c) can be conveniently carried out at a pressure lower than that of step (a) to facilitate the removal of the absorbed gas.

In some cases, the person skilled in the art can also conduct stage (c) at a temperature substantially equal to that of stage (a) or slightly higher, but operating at lower pressures than stage (a), or even applying pressures lower than the atmospheric one (under vacuum).

According to a preferred embodiment, step (c) can comprise a rapid evaporation (i.e., “flash”) of the acid gases contained in the liquid solution, by means of a rapid decrease in pressure in adiabatic or semiadiabatic conditions. The liquid mixture cools, releasing heat for the separation of acid gases. This embodiment is particularly convenient when the liquid mixture separated in step (b) is at relatively high temperatures, preferably between 40° C. and 100° C. In this case, the heating phase of the liquid solution must be provided for before entering stage (c), to temperatures of between 70° C. and 150° C.

The person skilled in the art conveniently selects the absorption temperatures of step (a) and desorption temperatures of step (c) according to the characteristics of the solvent system used, preferably so that the absorption temperature is lower than the desorption temperature, more preferably with a difference of at least 20° C.

Step (c) is conveniently conducted so that all or most of the acid gas contained in the liquid solution separated in (b) is removed and separated. Normally, over 90%, preferably over 95%, of the gas present in said liquid solution is separated in step (c).

For example, in step (c), conveniently, not all of the CO₂ is removed from the regenerated absorbent mixture, but rather a small amount, generally from traces of up to 1.9% by weight with respect to the weight of the regenerated solvent system, can remain absorbed in the solvent system, in order not to have to use very high desorption conditions and therefore to make the process more cost effective.

The process covered by the present disclosure enables the reduction of the acid gas content of a natural gas down to values lower than 1000 ppm, preferably lower than 500 ppm, more preferably lower than 100 ppm, the quantities being calculated in volume, assuming the ideal of gaseous mixtures.

Furthermore, the present disclosure allows for the reduction of the CO₂ content of a flue gas, generally not containing H₂S and optionally containing also water/water vapours, by up to 99% of the initial CO₂ in volume.

Thus the process of the present disclosure advantageously allows for the targeting of the specification values of acid gases for natural gas, as well as for exhaust or combustion gases, with a reduced energy consumption.

It has, in fact, been found that the amount of acid gas absorbed in step (a), with the same volume of absorbent mixture, is much greater than expected on the basis of the additivity rule of the individual components.

In other words, a volume composed, for example, of a litre of DBU/propanediol/1,3-dimethyl-imidazolidin-2-one (DMI) mixture by weight proportions of 50/30/20 absorbs much more acid gas than a litre of 1,3-dimethyl-imidazolidin-2-one, as the latter acts only by physical adsorption of CO₂, whilst the ternary mixture also shows an uptake of CO₂ by chemical bond determined by the combination of DBU and propanediol.

Even more surprisingly, it has been found that, following absorption, the viscosity of the absorbent mixture of the present disclosure increases much less than, for example, an ionic liquid of the known art, such as a mixture of DBU/propandiol/sulfolane.

The process according to the present disclosure can also be useful possibly for the removal of other undesirable compounds present in natural gas, such as, for example, mercaptans, down to values lower than 30 ppm, preferably lower than 15 ppm, more preferably lower than 5 ppm.

A further advantage of the process of the present disclosure is that the solution used for the absorption of sour gas (acid) can be regenerated at lower temperatures than those conventionally applied for the regeneration of amine solutions, i.e., at relatively low temperatures (thanks to the formation of alkyl carbonates instead of carbamates), as well as systems with reversible ionic liquids with different solvent, resulting in significant energy savings.

Further advantages can be summarised as follows:
at the same regeneration temperature, the mixture, after the carbonation reaction, develops a greater quantity of CO₂ (assessed as internal pressure in a closed reactor), regenerating itself more effectively;
after the carbonation reaction, the mixture has a lower viscosity than other known absorbing systems and can therefore be more easily processed in a CO₂ uptake plant, resulting in a lower energy impact for handling;
after the carbonation reaction, the mixture is not separated into phases and can therefore be more easily regenerated (CO₂ removal) by simple heating, which is the most efficient way of removing CO₂ from switchable ionic liquids compared with phase separators.

Other relevant advantages over prior absorbent mixtures are:
the elimination of foaming during the regeneration phase;
lower loss in the regeneration phase, in the case of diols as component B), thanks to their high boiling point, with both economic and environmental advantages;
the reduction or elimination of the dehydration treatment downstream of the softening stage in the case of diols such as component B), as the diols perform a high dehydrating action, which enables the reduction of the construction and management costs relating to the dehydration required in plants according to the state of the art.

The following embodiments are provided for the sole purpose of describing the present disclosure and must not be construed as limiting the scope of protection defined by the enclosed claims.

### EXAMPLES

### Solvents and Reagents

1,3-dimethyl-imidazolidin-2-one (>99%; Sigma-Aldrich)
1-Methyl-2-pyrrolidone (>99%; Sigma-Aldrich)
1,8-diazabicyclo(5.4.0)undec-7-ene (DBU; >99%; Sigma-Aldrich)
1,2-propandiol (>99%; Sigma-Aldrich)

### Example 1

### Absorption Test with Ternary Mixture DBU/1,2-propandiol/1,3-dimethyl-imidazolidin-2-one (DMI)

A ternary absorbent mixture is prepared in a quantity of 300 g consisting of 50% by weight of DBU, 30% by weight of 1,2-propanediol, 20% by weight of DMI.

This absorbent mixture is weighed on a precision balance and inserted inside a glass bubbler to start the absorption test (carbonation), feeding pure CO₂ until the mixture is saturated with CO₂.

This test simulates the absorption of CO₂ contained in a flue gas, which occurs mainly through chemical absorption, given that the flue gas is not under pressure, but is substantially at atmospheric pressure.

The bubbler, which operates at atmospheric pressure, is kept at room temperature (approximately 25° C.) to maximise absorption without resorting to external cooling.

The bubbler is also fitted with a gas outlet pipe.

The end of the absorption test is set when the CO₂ outlet flow rate, measured through a Ritter volumetric meter, is equal to that of the input CO₂ measured by a mass flow meter: this is precisely the condition in which the sorbent mixture is saturated with CO₂ at room temperature and atmospheric pressure.

The incoming CO₂ flow rate is fixed at 10 Nl/h of CO₂.

At the end of the absorption test, the incoming CO₂ flow is interrupted, leaving the sample to rest until it is observed that the weight of the sample remains constant (after around 2 hours): in this way, the physically adsorbed CO₂ is desorbed in the carbonated sample due to high viscosity.

Lastly, the sample saturated with only chemically absorbed CO₂ was weighed on a precision balance.

The difference by weight between the saturated mixture of chemically absorbed CO₂ and the starting weight is the quantity of CO₂ chemically absorbed by the interaction with the DBU and the alcohol (diol), given that the physically absorbed CO₂ is very low and close to zero at atmospheric pressure.

The CO₂ absorbed chemically by the reaction mixture is 14.5% by weight with respect to the weight of the mixture.

The viscosity of this carbonated reaction mixture is measured at 25° C. and 40° C. by means of the laboratory viscometer model Anton-Paar SVM 3001. No phase separation or turbidity is observed in said carbonated mixture, resulting in a homogeneous mixture.

| Carbonatate viscosity (cP) | Carbonatate viscosity (cP) |
|---|---|
| at 25° C. | at 40° C. |
| 3300 | 740 |

Said carbonated mixture is placed inside an autoclave with a measured internal volume of 203 cc and fitted with a thermocouple and a manometer to correctly measure the internal temperature and pressure due to the development of CO₂ (desorption of CO₂) at different temperatures.

The autoclave is inserted inside a thermostated Lauda oil thermal bath that allows it to be heated in a wide temperature range that covers both the operating conditions of absorption and regeneration in the column (40-150° C.).

The pressure, generated and induced by the gradual release of CO₂ inside the free ceiling of the autoclave, is measured by the pressure gauge positioned on the head.

The pressure and temperature data are shown in the following table.

| P | P | P | P | P | P |
|---|---|---|---|---|---|
| 40° C. | 70° C. | 90° C. | 110° C. | 130° C. | 150° C. |
| (barg) | (barg) | (barg) | (barg) | (barg) | (barg) |
| 0.2 | 3.8 | 8.6 | 16.2 | 27.0 | 39.6 |

### Example 2

### DMI Hydrolysis Test in a Basic Environment

The chemical stability on the hydrolysis of 1,3-dimethyl-imidazolidin-2-one (DMI)-component C) of the absorbent mixture of Example 1—in an alkaline environment (to simulate the strongly basic environment in which the solvent C) is found) was experimentally verified.

A ternary mixture was prepared in a quantity of 300 g consisting of:
90% by weight of DMI;
10% by weight of H₂O at 0.1M of NaOH (to simulate a strongly basic environment given by the base B) of the mixture according to the disclosure).

The solution was placed in an autoclave and brought to a temperature of 150° C. for approximately 3 hours.

Once the solution was drained, it was analysed using the ¹³C NMR (Nuclear Magnetic Resonance) technique, which detected 90% by weight of DMI and 10% by weight of H₂O, without the presence of hydrolysed DMI.

Therefore, under the basic reaction conditions of the CO₂ of the process according to the disclosure, solvent C) does not undergo hydrolysis.

### Example 3

### Absorption Test with Ternary Mixture DBU/1,2-propanediol/1-Methyl-2-pyrrolidone (NMP)

Example 1 was repeated by replacing the DMI with the NMP: the absorbent mixture prepared (300 g) therefore comprised 50% by weight of DBU, 30% by weight of 1,2-propanediol, 20% NMP.

The incoming CO₂ flow rate was set at 10 Nl/h of CO₂.

The CO₂ absorbed chemically by the reaction mixture is 14.5% by weight with respect to the weight of the mixture.

The viscosity of this carbonated reaction mixture was measured at 25° C. and 40° C. by means of the laboratory viscometer model Anton-Paar SVM 3001. In said carbonated mixture, no phase separation or turbidity was observed.

| Carbonatate viscosity (cP) | Carbonatate viscosity (cP) |
|---|---|
| at 25° C. | at 40° C. |
| 2550 | 570 |

Said carbonated mixture was treated at different temperatures, measuring the pressure of the CO₂ that had developed inside the autoclave, after being inserted into the thermal bath as in example 1.

The pressure, generated and induced by the gradual release of CO₂ inside the free ceiling of the autoclave, was measured by the pressure gauge positioned on the head, obtaining the values shown in the following table:

| P | P | P | P | P | P |
|---|---|---|---|---|---|
| 40° C. | 70° C. | 90° C. | 110° C. | 130° C. | 150° C. |
| (barg) | (barg) | (barg) | (barg) | (barg) | (barg) |
| 0.2 | 3.8 | 8.6 | 16.7 | 27.4 | 39.7 |

### Example 4

### NMP Hydrolysis Test in a Basic Environment

The chemical stability on the hydrolysis of 1-methyl-2-pyrrolidone (NMP) in an alkaline environment, component C) of the absorbent mixture of example 3, was experimentally verified, similarly to what was carried out in example 2.

A ternary mixture was prepared in a quantity of 300 g consisting of:
90% by weight of NMP;
10% by weight of H₂O at 0.1M of NaOH.

The solution was placed in an autoclave and brought to a temperature of 150° C. for approximately 3 hours.

The drained solution was analysed using the ¹³C NMR (Nuclear Magnetic Resonance) technique, which detected 89.6% by weight of NMP, 0.6% by weight of hydrolysed NMP (X-NMP) and 9.8% by weight of H₂O.

Of the initial NMP present, 99.4% by moles remained non-hydrolysed NMP, whilst 0.6% by moles transformed into X-NMP according to the reaction shown below.

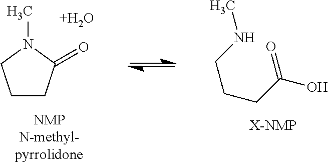

### Example 5 (Comparative)

### Absorption Test Using DBU/1,2 Propandiol/Sulfolane Ternary Mixture

Example 1 was repeated by replacing the DMI with sulfolane: the absorbent mixture prepared (300 g) therefore comprised 50% by weight of DBU, 30% by weight of 1.2 propanediol, 20% sulfolane.

The incoming CO₂ flow rate was set at 10 Nl/h of CO₂.

The CO₂ absorbed chemically by the reaction mixture is 14.5% by weight with respect to the weight of the mixture.

The viscosity of this carbonated reaction mixture was measured at 25° C. and 40° C. by means of the laboratory viscometer model Anton-Paar SVM 3001.

| Carbonatate viscosity (cP) | Carbonatate viscosity (cP) |
|---|---|
| at 25° C. | at 40° C. |
| 10000 | 2200 |

Said carbonated mixture is inserted into the thermal bath as in example 1 and subjected to different temperatures, measuring the pressure of the CO₂ that has developed inside the autoclave.

The pressure, generated and induced by the gradual release of CO₂ inside the free ceiling of the autoclave, was measured by the pressure gauge positioned on the head, obtaining the values shown in the following table:

| P | P | P | P | P | P |
|---|---|---|---|---|---|
| 40° C. | 70° C. | 90° C. | 110° C. | 130° C. | 150° C. |
| (barg) | (barg) | (barg) | (barg) | (barg) | (barg) |
| 0.1 | 2.4 | 6.6 | 13.8 | 23.4 | 35.1 |

TABLE 1
(summary)

| | CO₂ absorbed | | |
|---|---|---|---|
| | (% w/w absorbent | Viscosity (cP) | Viscosity (cP) |
| | mixture) | at 25° C. | at 40° C. |
| Example 1 | 14.5 | 3300 | 740 |
| Example 3 | 14.5 | 2250 | 570 |
| Example 5 | 14.5 | 10000 | 2200 |
| (cfr) | | | |

From the comparison of the data of table 1 (summary), it can be observed that the carbonated solvent system containing the C) solvents according to the present disclosure shows a viscosity, at the same temperature, that is much lower (about 1 order of magnitude) than that of known carbonated solvent systems that use different solvents resistant to hydrolysis, such as, for example, sulfolane.

TABLE 2
(summary)

| | P | P | P | P | P | P |
|---|---|---|---|---|---|---|
| | 40° C. | 70° C. | 90° C. | 110° C. | 130° C. | 150° C. |
| | (barg) | (barg) | (barg) | (barg) | (barg) | (barg) |
| Example 1 | 0.2 | 3.8 | 8.6 | 16.2 | 27.0 | 39.6 |
| Example 3 | 0.2 | 3.8 | 8.6 | 16.7 | 27.4 | 39.7 |
| Example 5 | 0.1 | 2.4 | 6.6 | 13.8 | 23.4 | 35.1 |
| (cfr) | | | | | | |

From the comparison of the data shown in table 2, it can be observed that, although the amount of CO₂ absorbed is equal (14.5% by weight in all examples 1, 3 and 5 (comparative)), the carbonated solvent system containing the C) solvents according to the present disclosure shows, at the same regeneration temperature, a higher internal pressure in the autoclave with respect to that generated by known carbonated solvent systems that use different solvents resistant to hydrolysis, said higher internal pressure being the index of a greater release of CO₂ at the same temperature.

This greater desorption, which was unexpected and surprising, is especially advantageous at low temperatures, given that it makes it possible to carry out, even at low temperatures, such as, for example, in the range of between 40° C. e 80° C., a greater removal of CO₂ (greater desorption of CO₂ from the absorbent system and, therefore, greater desorption efficiency) compared with the absorbent systems that use physical solvents other than the cyclic ureas and lactams of the present disclosure.

1. An absorbent mixture usable for the removal of acid gases from gas mixtures containing them, from gaseous mixtures not containing H₂S, comprising:
A) at least one alcohol of general formula R(OH)ₙ having a normal boiling point equal to or greater than 75° C., wherein R is a is a linear or branched, optionally substituted, alkyl or alkyl aromatic group having 2 to 20 carbon atoms and wherein n is an integer that varies between 1 to 20;
B) at least one organic base with a pK_{b} (in water) less than or equal to 3; and
C) a solvent based on one or more heterocyclic compounds selected among cyclic ureas having a five-membered or six-membered atom ring of formula (IV) and/or (V); cyclic lactams having a five-membered or six-membered atom ring of formula (VI) and/or (VII); or combinations thereof: 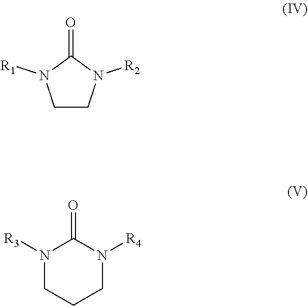
wherein R1, R2, R3, R4 in formula (IV), (V) are independently selected from H, linear or branched alkyl groups having between 1 and 10 carbon atoms, said R1, R2, R3, R4 optionally including, independently from one another, one or more —OH groups; 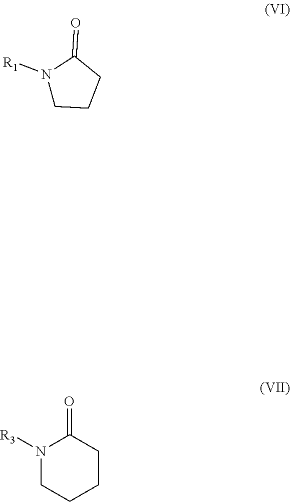
wherein R1 and R3 in formula (VI), (VII) are independently selected from H, linear or branched alkyl groups having 1 to 10 carbon atoms, said R1, R3 optionally including, independently from one another, one or more —OH groups.

2. The mixture according to claim 1, wherein components A), B) and C) are included in said absorbent mixture in the following proportions by weight (weight ratios):
B/A of between 0.1 and 2.5;
C/A of between 0.1 and 2.

3. The absorbent mixture according to claim 1, wherein alcohol A) is selected from any of the following classes:
linear or branched aliphatic alcohols, optionally fluorinated, with a single —OH group (n=1) and having 4 to 20 carbon atoms;
aliphatic polyols having 2 to 10 —OH groups (n from 2 to 10 and having 2 to 20 carbon atoms;
alkyl aromatic alcohols having 1 to 3 aliphatic OH groups (n from 1 to 3) and 7 to 15 carbon atoms, comprising at least one aryl group.

4. The mixture according to claim 1, wherein component A) of the mixture is 1,2-propandiol or 1,3-propandiol, or mixtures thereof.

5. The absorbent mixture according to claim 1, wherein said organic base B) has a pK_{b} lower than or equal to 2.

6. The absorbent mixture according to claim 1, wherein said organic base B) has a normal boiling point at least higher than 75° C.

7. The absorbent mixture according to claim 1, wherein said organic base B) is a nitrogenous organic compound with low volatility (i.e. having a normal boiling point at least higher than 75° C.), comprising 5 to 25 N atoms.

8. The absorbent mixture according to claim 1, wherein said organic base B) is selected from the group consisting of 1,8-diazabicyclo(5.4.0)undec-7-ene (DBU) [pK_{b} 1.1], 1,5-diazabicyclo[4.3.0]non-5-ene (DBN) [pK_{b} 0.5], 1,1,3,3-tetramethylguanidine (TMG) [pK_{b} 0.4], derivatives of biguanide (1-(diaminomethylidene) guanidine such as N″-[(dimethylamino)(methylimino)methyl]-N,N,N′,N′-tetramethyl-guanidine, 1,8-bis-(tetramethylguanidine)naphthalene, phosphazene-type compounds such as N″,N′″″,N″″″″-phosfinimilidinetris[N,N,N′,N′-tetramethylguanidine], 1,8-bis(tetramethylamino)naphthalene or mixtures thereof.

9. The absorbent mixture according to claim 1, wherein solvent C) is selected from the cyclic ureas of formula (IV), (V), or mixtures thereof, preferably 1,3-dimethyl-imidazolidin-2-one (DMI), 1,3-dimethyl-3,4,5,6-tetrahydro-2(1H)-pyrimidinone (DMPU).

10. The absorbent mixture according to claim 1, comprising:
A) 1,2-propandiol or 1,3-propandiol in a weight percentage of between 45% and 65%;
B) diazabicycloundecene (DBU) in a weight percentage of between 25% and 35%;
C) cyclic urea of formula (IV), (V) or lactam of formula (VI), (VII), preferably a cyclic urea of formula (IV), (V), more preferably 1,3-dimethyl-imidazolidin-2-one, in a weight percentage of between 5% and 25%,
the weight content of each component A), B) and C) being selected in such a way that their sum is 100%.

11. A process for the removal of acid gases, from a gaseous mixture containing them, from a gaseous mixture not containing H₂S, including the following stages in sequence:
(a) placing said gaseous mixture, at a temperature of between 0° C. and 100° C. and at a pressure of between 50 kPa and 15 MPa, in contact with a solvent system comprising an absorbent mixture as defined in claim 1, to obtain a purified gaseous mixture and a liquid solution comprising at least a part of said acid gases;
(b) separating the purified gaseous mixture from said liquid solution obtained in step (a), and
(c) regenerating the solvent system usable in step (a) and forming a separate gaseous mixture comprising said acid gases, by heating said liquid solution separated in step (b),
(d) optionally, recycling to said step (a) the solvent regenerated in step (c).

12. The process according to claim 11, further comprising said step (d), wherein said solvent system regenerated in step (c) is recycled to said step (a).

13. The process according to claim 11, wherein said gaseous mixture containing acid gases which is fed to step (a) consists of natural gas, air, flue gas comprising CO₂, H₂O, nitrogen or oxygen, or syngas comprising CO₂, CH₄, H₂, H₂O.

14. The process according to claim 11, wherein said steps (a) and (b) are carried out in the same device.

15. The process according to claim 11, wherein step (c) is carried out at a temperature of between 40° C. and 180° C.

16. The process according to claim 11, wherein step (c) is carried out at a pressure lower than that of step (a).
